(19) United States
(12) Patent Application Publication
(10) Pub. No.: US 2007/0106417 A1
(43) Pub. Date: May 10, 2007

(54) Method of carving three-dimensional artwork

(76) Inventor: Wesley V. Barbir, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/588,565

(22) Filed: Oct. 27, 2006

Related U.S. Application Data
(60) Provisional application No. 60/732,106, filed on Nov. 1, 2005.

(51) Int. Cl. G06F 19/00

(52) U.S. Cl. 700/182; 700/186

(57) ABSTRACT

A method of producing intricate, three-dimensional artwork requiring high resolution on the part of a Computer Numerical Control (CNC) machine is disclosed. An existing three dimensional carving is captured by a computer, and converted into a NURBS surface. The operator sets forth the dimensions of the surface to be carved, including the width and the length, as well as the width of its component stiles and rails. The operator further selects the corners of such surface in which the artwork is to be carved. Thereafter, the NURBS surface is scaled and positioned in accordance with the dimensions and parameters supplied, and transmitted to respective CNC machines. The CNC machines then perform a series of carving operations in accordance with the instructions supplied by a G-code file processed from the NURBS surfaces.

### CROSS-REFERENCE TO RELATED APPLICATIONS

This application relates to and claims the benefit of U.S. Provisional Application No. 60/732,106 filed Nov. 1, 2005 and entitled METHOD OF CARVING THREE-DIMENSIONAL ARTWORK which is wholly incorporated by reference herein.

### STATEMENT RE: FEDERALLY SPONSORED RESEARCH/DEVELOPMENT

Not Applicable

### BACKGROUND

1. Technical Field

The present invention relates to methods for producing carved doors, and more particularly to methods for carving intricately detailed designs on doors using computer numerical control (CNC) machinery.

2. Related Art

Doors used in cabinets, houses, and other like structures are commonly constructed of wood. Further, it is also common for such wood doors to include ornamental designs which impart a decorative appearance thereto, enhancing the aesthetic appeal of the area in which such ornamental wood doors occupy, be it a house, a kitchen, a bedroom, or other like areas in which a door would typically be utilized. One of the most common of such aesthetic designs is that which imparts a frame-like appearance to the door, where the inner surface of the door appears beveled after routing about the border of the same. Typically, such ornamental designs are hand-carved using chisels, gouges, mallets, and the like.

Automated carving techniques typically utilize Computer Numerical Control (CNC) machines. CNC machines typically include a computer controller that regulates the operation of machine tools. The machine tool includes a motive force such as an electrical motor under the control of the computer, and a tool bit that cuts, drills, routes or otherwise removes material from a work piece. The computer is provided with programming that sequences the movement along the work piece as well as the cutting/drilling/routing operations. The programming is typically provided as G-code, which can be produced by various Computer Aided Manufacturing (CAM) software packages. G-code includes instructions that represent linear movement as well as circular or arcuate movement of the machine tool. Additional instructions relating to machining speeds, orientation of the work piece, and selection of cutting tools may also be includes in the G-code instructions. Where a contour cannot be represented by basic linear and circular segments, series of short lines or curves are substituted that approximate such a contour. Typically, the G-code generated by the CAM software is parsed by a post-processor that optimizes the G-code for a particular CNC machine. As will be appreciated, the CNC machine improves quality and consistency in the completed product, and so is particularly suited for mass-production purposes.

Another popular decorative appearance imparted to doors is an intricate design depicting a variety of real-world objects, such as leaves, vines, fruits, and the like. While two-dimensional carvings are popular, three-dimensional carvings having life-like appearances are also in demand. Despite the advent of CNC machines capable of automating most carving operations, the production of such designs remained relegated to manual labor. As will be readily appreciated by a person of ordinary skill in the art, early CNC machines lack the requisite resolution to produce such detailed three dimensional designs. Generally, with improvements to the resolution of the CNC machinery, it became possible to carve such detailed designs in an automated fashion, albeit not on doors and other large structures. While the CNC machine had the requisite resolution, there was also an attendant reduction in the surface area within which the machine tools of the CNC machine could be guided. When carving the intricate three dimensional designs mentioned above, it was necessary for the work piece area to be limited to an area approximately six inches by six inches. Clearly, this is insufficient for carving designs on doors and other like structures, as the work piece areas for doors are orders of magnitude larger.

Therefore, there is a need in the art for a three dimensional wood carving method which can accommodate large surface area objects such as doors and the like. Further, there is also a need in the art for such method that can operate under the constraints of existing CNC machinery. These objects and more are realized in the present invention, the details of which will be come apparent hereinafter.

### BRIEF SUMMARY

In light of the foregoing limitations, the present invention was conceived. According to one aspect of the present invention, a method for carving detailed three dimensional designs in wood structures is provided. Such production method involves the use of a personal computing apparatus to digitally capture an existing three dimensional artwork into a point cloud, and cleaning such data to enable improved polygonization. In polygonization, the artwork is converted into a Non-Uniform Rational B-Spline surface, and the resulting data is scalable and stretchable. Further, such method receives as input a variety of parameters associated with a door, including, but not limited to, the width, the length, the width of the stiles and rails associated therewith, and automatically scales the converted artwork for carving thereon. At least one, and up to all of the four corners may be designated by the operator to be carved with the artwork, and the artwork is mirrored and flipped to correspond to each of the corners of the door.

In accordance with another aspect of the present invention, a series of CNC G-codes is produced for each of the carvings on the door, and uploaded to a series of CNC machinery which implement the instructions as set forth in the CNC G-codes. Following the upload of the G-codes, the CNC machinery begins operation and carves the artwork into the door. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a conventional door broken down into its components in accordance with an aspect of the present invention;

FIG. 2 is an exemplary screen for inputting the dimensions of a door to be carved in accordance with an aspect of the present invention;

FIG. 3 is an exemplary screen for selecting which corners of a door to be carved in accordance with an aspect of the present invention;

FIG. 4 is a procedural flowchart of the method for carving a door in accordance with an aspect of the present invention; and

FIG. 5 is an exemplary design for carving on a door in accordance with an aspect of the present invention.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, top and bottom, and the like are used solely to distinguish one from another entity without necessarily requiring or implying any actual such relationship or order between such entities.

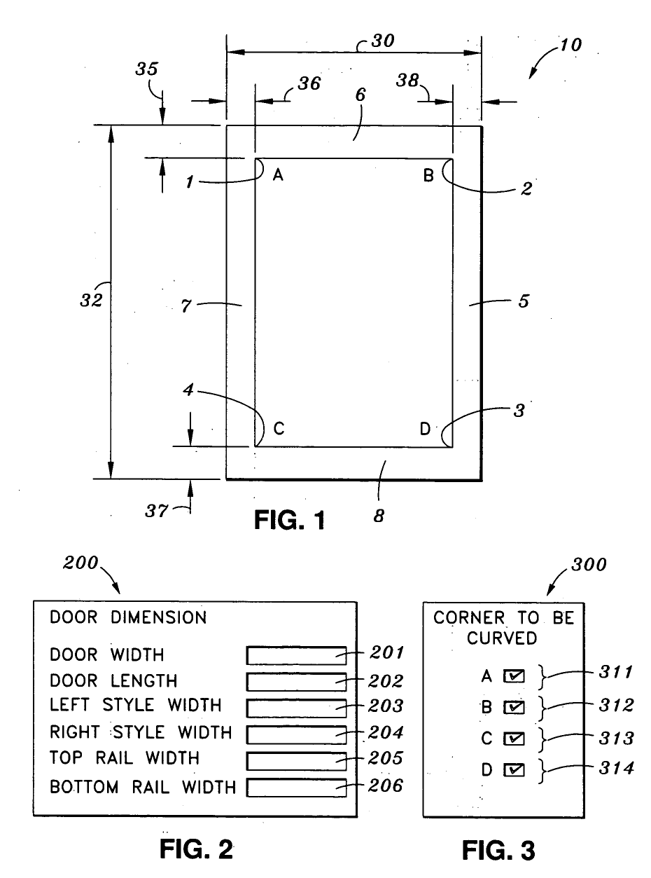

With reference now to the figures, and specifically to FIG. 1, a conventional wooden door 10 is shown. The door 10 has a top rail 6 in a generally opposed, parallel relation to bottom rail 8, and a left stile 7 in a generally opposed, parallel relation to a right stile 5. Further, the top rail 6 is in a perpendicular relation to the left stile 7 and the right stile 5, and the bottom rail 8 is in a perpendicular relation to the left stile 7 and the right stile 5. Thus, the intersection of the left stile 7 and the top rail 6 defines an upper left corner 1, the intersection of the right stile 5 and the top rail 6 defines an upper right corner 2, the intersection of the right stile 5 and the bottom rail 8 defines a lower right corner 3, and the intersection of the bottom rail 8 and the left stile 7 defines a lower left corner 4. With regard to dimensions, the left stile 7 is defined by a left stile width 36 and a door length 32, and the right stile 5 is defined by a right stile width 38 and the door length 32. The top rail 6 is defined by a top rail height 35 and a door width 30, while the bottom rail 8 is defined by the bottom rail height 37 and the door width 30. Preferably, the door 10 is constructed of wood by any one of conventional methods known in the art. Further, while specific reference has been made to the door 10 and attendant parts thereof, it is understood that the present invention is not limited to embodiments that solely include such entities, and can utilize any flat surface. As such, the present invention is contemplated as having application to conventional full-sized doors that are attachable to entryways into rooms and buildings, as well as to cabinet doors and other like doors for use with smaller-sized structures. Additionally, the present invention may be utilized for carving large picture frames and the like.

With reference to FIG. 2, each of the aforementioned dimensions is entered into a dialog box 200 as displayed by a data processing apparatus with a screen and one or more input devices. The dialog box 200 has data input boxes 201-206 for each of the relevant parameters as required for implementing the methods in accordance with an aspect of the present invention. More particularly, an operator may key into the input box 201 the value of door width 30, into the input box 202 the value of door length 32, into the input box 203 the value of left stile width 36, into the input box 204 the value of right stile width 38, into the input box 205 the value of top rail height 35, into the input box 206 the value of bottom rail height 37. It will be appreciated that the input boxes each have accompanying descriptions that denote the particular dimension being entered. Measurements may be entered into each of respective input boxes 201-206 in any measurement unit such as that of the English system, the metric system, or any other suitable system that is capable of being recognized by the CNC machine. It will be understood that the above-described interface may be implemented on a character-based display system common in older computer systems, where navigation between the input boxes 201-206 is accomplished via key entries, for example, the tab or arrow keys. Of course, the interface may be implemented on graphical user interfaces where the user has the option of navigating between the input boxes 201-206 by maneuvering a mouse, or with key entries as indicated above. Along these lines, the data pertaining to the respective dimensions may be entered in any desired order.

Additionally, as shown in FIG. 3, a dialog box 300 has check boxes 311-314 for selecting which corners of door 10 to carve. Check box 311 selects or deselects carving the upper left corner 1, and check box 312 selects or deselects carving the upper right corner 2. Further, check box 313 selects or deselects carving the lower right corner 3, and check box 314 selects or deselects carving the lower left corner 4. It will be appreciated that while in some circumstances it will be desirable to carve all four corners with the same design, but in other circumstances, it may be desirable to carve one or more corners with different designs. According to one aspect of the present invention, the first design may be carved in specified corners in a first iteration, and the remaining corners can be carved in a second or later iteration.

Upon entering all of the required parameters, the carving process is initiated. As will be discussed in further detail below, the aforementioned data is essential to the proper scaling and placement of a chosen three dimensional graphic design on the door 10.

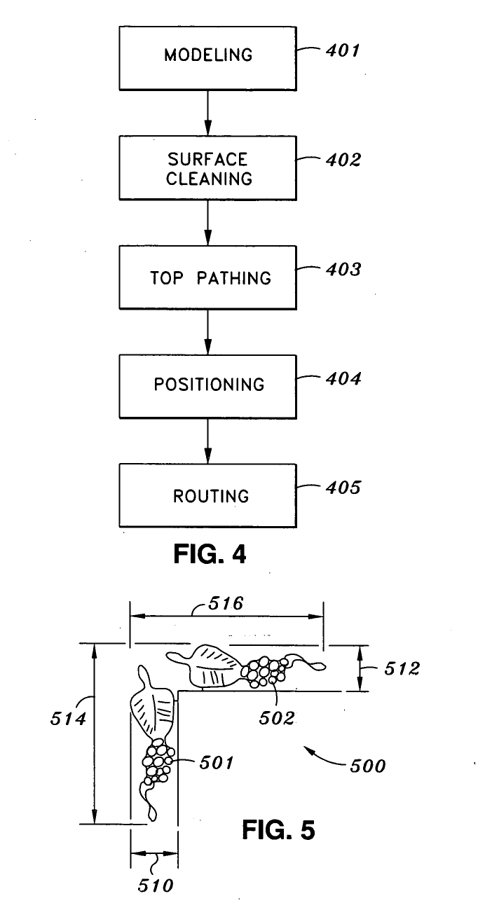

Referring to FIG. 4, the overall process of the present invention will now be described. In the presently preferred method, a CAD/CAM (Computer Aided Design/Computer Aided Manufacturing) application program is utilized in all relevant steps. More particularly, the Artcam product from Delcam USA of Salt Lake City, Utah is utilized, which includes three-dimensional CNC capability for generating CNC command data. The input dialog boxes and the data processing operations associated therewith as described above, as well as the processing of the inputted data to manipulate the carving process as will be described in further detail below, may be implemented as a macro on the Artcam software application. The use of Artcam as presently disclosed is by way of example only and not of limitation, and any software application having CNC capabilities may be utilized.

As understood, a three dimensional model of any structure may be created on a computer workstation in accordance with a variety of well known techniques. In the modeling step 402, where a pre-existing physical carving is available, the carving is preferably scanned. More particularly, a laser scans across the carving and measures the flight time of the laser pulse to determine the distance from the scanner to each point on the carving that reflects the laser. The movement of the laser is typically controlled by a computer. Each of the points on the carving is assigned a set of coordinates as well as a depth value, and this data is transmitted back to the computer. Upon scanning, a point cloud of three dimensional points that represent the carving is produced by the computer which controls the scanner. Prior to the scan, the name of the scan, the size of the carving, and the positioning of the scanner is defined and entered into the computer by the operator. As will be appreciated by one of ordinary skill in the art, laser scanners may not be capable of scanning highly reflective or highly absorptive surfaces. In a preferred embodiment of the present invention, the surface of the carving may be coated with any dulling material well known in the art prior to scanning.

After obtaining the point cloud, the model represented thereby is manipulated for improved efficiency in transforming the same into a polygonal mesh. Among the well recognized operations include smoothing the transition between data points and eliminating extraneous data points through noise reduction. As will be appreciated by those having ordinary skill in the art, a variety of noise reduction techniques exist, such as the application of Gaussian filters on the point cloud data. In this technique, a mask comprised of a Gaussian function is convolved with the point cloud. This results in individual point cloud data points that are closer in value to its neighbors. As will be further appreciated, however, Gaussian filter noise reduction techniques blur legitimate edges on the point data. Alternatively, non-linear filters such as median filters may be applied to the point cloud, whereby each point is compared to neighboring points to determine the intensity thereof. Median values are determined based on the comparison to such neighboring points, and the particular point under analysis is re-adjusted to the median value. It is understood that this noise reduction technique is useful for eliminating “salt and pepper noise” from image data, without compromising the appearance of edges with blurring.

Upon completing the point cloud clean-up process, the data in the point cloud is transformed into a polygonal mesh, which is a mathematical representation of the surfaces captured in the point cloud. As known in the art, the polygonal mesh is a set of polygons such as triangles, quadrilaterals, etc., and/or vertices that define a three-dimensional object. The computer produces the polygonal mesh by a triangulation process applied to the point cloud. Thereafter, the polygonal mesh model is edited to fill any existing holes in the same where insufficient data was collected. Additionally, boundaries are verified and repaired for a continuous, uninterrupted surface, and the number of control points defining the polygon are increased or decreased for a smooth outline of the polygonal mesh.

As an alternative to the above-described process of generating a polygonal mesh from a scanned point cloud, a designer may directly model the carving on existing CAD computer systems. CAD software packages are typically provided with user interfaces that allow for the input and editing of various three dimensional structures as wire frame models, solid models, and freeform surface models. Such designs are exportable to the aforementioned polygonal mesh models for further processing. In some instances, such as where small and intricate details are present in the design, it may be preferable to directly model it directly as described even though it may be quicker to scan an existing model.

From the polygonal mesh model a Non-Uniform Rational B-Spline (NURBS) surface model is created by a meshing/patching process. The NURBS model can be either open or closed. As will be understood by a person having ordinary skill in the art, NURBS can create a robust and accurate geometric description of the carving so that the definition of a contour is not lost. At the routing stage NURBS can define points along the contour such that a CNC machine can interpolate the arcs along the path created by the points. Thus, NURBS data can be used to control the CNC machine movements via the CNC controller to perform a highly accurate and improved surface finish. First, patches are uniformly arranged in a layout to represent the shape of the carving, and a high grid-resolution structure is laid on each individual patch. Thereafter, a NURBS surface is fit to each patch, while retaining tangent continuity across all patch boundaries. This step involves defining the various curvatures of the carving, wherein a contour line is determined by the number of curvature changes in the carving model. Using this information the model is separated into regions of high curvature change and low curvature changes, and contour lines are defined. It is contemplated that contour lines connected into closed loops are the most efficient. The NURBS surface is then divided into quadrangular patches, and each patch is connected by four polylines, or patch boundaries, which are arranged to cover the polygonal surface of the carving model. The resulting NURBS surface model is preferably exported as an IGES (Initial Graphics Exchange Specification) file, a neutral data format comprised of 80-character ASCII files.

Upon modeling the three-dimensional carving as a NURBS model, such resulting model is scaled to the appropriate size, and measurement accuracy and quality of surface is verified. With reference to FIG. 5, an exemplary carving model 500 is illustrated, comprised of a vertical portion 501 and a horizontal portion 502. It will be appreciated that though the carving model 500 is patterned after a leaf and fruits attached thereto, any suitable decorative elements may be readily substituted without departing from the scope of the present invention. It is contemplated that while the carving model 500 is unitary, that is, contained in one NURBS surface model, the vertical portion 501 and the horizontal portion 502 appear separated. It is also possible for the vertical portion 501 and the horizontal portion 502 to appear connected, if desired. The carving model 500 is approximately one and one quarter inches by four inches (1¼″×4″). Still referring to FIG. 5 and now also back to FIGS. 1 and 2, the dimensions as inputted into form 200 are utilized to scale carving model 500 so that the final carving will be properly placed on door 10. For example, based on the dimensions of left stile width 36 and top rail height 35, the carving model 500 is scaled so that the vertical portion 501 has an appropriate width 510 less than or equal to the left stile width 36. As such, the vertical portion 501 fits within the confines of the left stile 7. Additionally, the carving model 500 is scaled so that the horizontal portion 502 has an appropriate height 512 less than or equal to the top rail height 35 so that the horizontal portion 502 fits within the confines of the top rail 6. It is understood that height 514 of the vertical portion 501 may be greater than the top rail height 35, and width 516 of the horizontal portion 502 is greater than the left stile width 36. In this regard, the vertical and horizontal portions 501, 502 can extend into the top rail 6, and the left stile 7, respectively, without being bound within the intersecting areas thereof.

In the toolpathing step 403, the G-code representative of the carvings for each of the corners is generated. As described above, G-codes are instructions that represent movements of the machine tools, and are processed by the CNC machine. In generating these instructions from the NURBS model, the relative locations of the toolpaths about the dimensions of the door 10 are adjusted. Where additional corners are selected to be carved as set in form 300 of FIG. 3, a mirror of the model 500 is correspondingly generated in accordance with the dimensions as inputted in the form 200, with the appropriate scaling being performed as described above. A separate G-code file is generated for each corner to be carved, and thus specifying the position of each of the toolpaths according to the positioning step 404.

As will be understood by a person of ordinary skill in the art, for any given carving tasks the CNC G-code generated may require multiple tools and multiple toolpaths. In production settings such toolpaths are typically merged for further speed and efficiency, but during prototyping it is often desirable not to merge such toolpaths. Accordingly, prior to generating the CNC G-code, an option may be selected by the operator to merge or not to merge toolpaths.

For each of the corners selected, a separate G-code file is generated for uploading to CNC machines which sequentially perform the carving. As such, each G-code file is named to enable quick locating and uploading to the CNC machine. For example, the G-code file containing the first operation and the first tool is named “1GRPPN1.nc,” the G-code file containing the second operation and the first tool is named “2GRPPN1.nc,” and so forth. It is contemplated that the initial number is representative of the operation number, and the last number is representative of the tool number, and the characters therebetween are representative of a carving description. The exemplary “2GRPPN1.nc” file contains the second operation, of a first tool, related to the GRPPN carving. While reference has been made to a specific naming convention, the present invention is not limited as such, and any appropriate naming convention capable of quickly identifying the operation number, the tool number, and the description of a carving may be used.

After uploading the G-code to each of the CNC machines, in routing step 405 the carvings are made into door 10 by way of methods well known in the art. In a preferred embodiment, each of the selected corners is carved by a separate machine, but alternatively, the door 10 may be rotated and carved by a single machine. The rotation of the door 10 may be handled by a second machine. Along these lines, it is also contemplated that the CNC machine may also be rotated about the door 10 to each corner.

Following the routing step 405, the surfaces of the carving may be sanded and smoothed according to one of numerous well-known techniques. Various stains and finishes may also be added prior to installation.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A method for carving design onto a structure with computer numerical control (CNC) machines, the method comprising the steps of:
receiving a model representative of the design;
receiving a set of dimensions of the structure;
generating a first set of toolpaths from the model, the first set of toolpaths positioned on a first section of the structure and being scaled to be confined within the dimensions of the structure;
transforming the first set of toolpaths into a second set of toolpaths positioned on a second section of the structure different from the first section of the structure, the second set of toolpaths being scaled to be confined within the dimensions of the structure; and
transmitting the first set of toolpaths to the CNC machine for execution.

2. The method of claim 1, wherein the step of receiving the set of dimensions is followed by receiving a selection of at least one section of the structure for carving the three-dimensional design thereon.

3. The method of claim 1, wherein the first set of toolpaths includes one or more merged toolpaths.

4. The method of claim 1, wherein the first set of toolpaths includes a subset of toolpaths correlated to a first tool.

5. The method of claim 1, wherein the structure is a door having a plurality of corners, the first section of the structure being a first corner, and the second section of the structure being a second corner.

6. The method of claim 5, wherein the set of dimensions include a door width, a door length, a left stile width, a right stile width, a top rail width, and a bottom rail width.

7. The method of claim 1, wherein the model is a non-uniform rational b-spline (NURBS) surface.

8. The method of claim 7, wherein the NURBS surface is generated from a polygon model of the three-dimensional design.

9. The method of claim 8, wherein the polygon model of the three-dimensional design is derived from a point cloud.

10. The method of claim 8, wherein the polygon model of the three-dimensional design is digitally modeled.

11. A machine readable medium having stored thereon executable program code which, when executed, causes a machine to perform a method for carving design onto a structure with computer numerical control (CNC) machines, the method comprising:
receiving a model representative of the design;
receiving a set of dimensions of the structure;
generating a first set of toolpaths from the model, the first set of toolpaths positioned on a first section of the structure and being scaled to be confined within the dimensions of the structure;
transforming the first set of toolpaths into a second set of toolpaths positioned on a second section of the structure different from the first section of the structure, the second set of toolpaths being scaled to be confined within the dimensions of the structure; and
transmitting the first set of toolpaths to the CNC machine for execution.

12. The machine readable medium of claim 11, wherein the step of receiving the set of dimensions is followed by receiving a selection of at least one section of the structure for carving the three-dimensional design thereon.

13. The machine readable medium of claim 11, wherein the first set of toolpaths includes one or more merged toolpaths.

14. The machine readable medium of claim 11, wherein the first set of toolpaths includes a subset of toolpaths correlated to a first tool.

15. The machine readable medium of claim 11, wherein the structure is a door having a plurality of corners, the first section of the structure being a first corner, and the second section of the structure being a second corner.

16. The machine readable medium of claim 15, wherein the set of dimensions include a door width, a door length, a left stile width, a right stile width, a top rail width, and a bottom rail width.

17. The machine readable medium of claim 11, wherein the model is a non-uniform rational b-spline (NURBS) surface.

18. The machine readable medium of claim 17, wherein the NURBS surface is generated from a polygon model of the three-dimensional design.

19. The machine readable medium of claim 18, wherein the polygon model of the three-dimensional design is derived from a point cloud.

20. The machine readable medium of claim 18, wherein the polygon model of the three-dimensional design is digitally modeled.
